(19) United States
(12) Patent Application Publication
(10) Pub. No.: US 2012/0328733 A1
(43) Pub. Date: Dec. 27, 2012

(54) Process and Kit for Accelerated Production of Wine or Beer

(76) Inventor: Mike Thom, Coopersburg, PA (US)

(21) Appl. No.: 13/534,116

(22) Filed: Jun. 27, 2012

Related U.S. Application Data
(60) Provisional application No. 61/501,414, filed on Jun. 27, 2011.

(51) Int. Cl. C12G 1/022; C12G 3/00

(52) U.S. Cl. 426/15; 426/16; 426/599

(57) ABSTRACT

The production of a fermented alcoholic beverage in small to medium size batches primarily in home wine and beer making kits is accelerated by a process wherein a combination of diammonium phosphate and yeast hulls are added to unfermented fruit juice or barley hop prior to fermentation. In this process, fermentation is complete in a week or less.

### FIELD OF THE INVENTION

The invention is directed to an accelerated process for producing wine or beer, and a kit therefore. More particularly, it relates to a home-use process for making wine in ten days or less, preferably in about 7 days.

### BACKGROUND OF THE INVENTION

Home winemaking has achieved a considerable degree of popularity as a hobby. Its appeal, however, is often limited due to a number of factors relating to the difficulty of making the wine such as maintaining acceptable conditions such as temperature and humidity, concentration and composition of ingredients and, importantly, time. With standard techniques and commonly used ingredients, a satisfactory table wine can take a year or longer to produce. Moreover, the procedures involved are often time-consuming and inconvenient. Such procedures include extraction of juices, preparation of must, cleaning and sterilizing equipment, obtaining necessary ingredients, commencing fermentation, specific gravity testing, racking, bottling and storing. Not to mention, the costs for the equipment can run into the hundreds or even thousands of dollars. It is an object of the invention to provide a simple process for making wine or beer in less than 10 days. Yet another object of the invention is to provide a kit containing the necessary equipment and ingredients in the appropriate concentrations for making wine or beer in less than ten days.

### SUMMARY OF THE INVENTION

The fermentation of a fruit juice is accelerated by a process comprising adding bentonite, diammonium phosphate and yeast hulls to a fruit juice concentrate or a fruit juice and water mixture in order to form a wine must. An active yeast is then mixed into the must, and the juice or juice/water mixture is then allowed to ferment in a warm, dark environment for 3 to 7 days, or until the fermentation process is complete or nearly complete. Sediment from the wine must is removed, and a combination of potassium sorbate and potassium metabisulfite are then added to the wine must to kill any remaining live active yeasts. The wine must is then degassed to remove excess carbon dioxide, and one or more clearing agents are added to the wine must. The must is then rested for an additional 3-5 days, after which the wine is fully fermented and ready to drink.

For making beer, the fermentation of a malt extract is accelerated by a process comprising adding bentonite, diammonium phosphate and yeast hulls to a liquid malt extract or dry malt extract and water mixture in order to form a beer wort. An active yeast is then sprinkled on top of the wort and the wort or malt extract/water mixture is then allowed to ferment in a warm, dark environment for 3 to 5 days, or until the fermentation process is complete or nearly complete. Sediment from the beer wort is removed, and then carbonating sugar is added to the beer wort to promote carbonation of the final wort with the remaining live active yeasts. Thereafter, wort is bottled to promote carbonation in the bottle. The beer wort is rested for an additional 3-5 days, after which the beer is fully carbonated and ready to drink.

### DETAILED DESCRIPTION OF THE INVENTION

As used herein, the term “wine” relates to any consumable alcoholic beverage produced by the fermentation of fruit juice. The term “beer wort” relates to any consumable alcoholic beverage produced by the fermentation of barley hops. The term “fermentation” relates to the process for converting sugar to carbon dioxide and ethyl alcohol using yeasts or other microbes under anerobic conditions. The term “yeast hull” or “yeast ghost” relates to a cell wall/cell membrane complex of an inactive or dead yeast.

The fermentation of a fruit juice is accelerated by a process comprising adding bentonite, diammonium phosphate and yeast hulls to a fruit juice concentrate or a fruit juice and water mixture in order to form a wine must. An active yeast is then sprinkled on top of the must and the juice or juice/water mixture is then allowed to ferment in a warm, dark environment for 3 to 5 days, or until the fermentation process is complete or nearly complete. Sediment from the wine must is removed, and a combination of potassium sorbate and potassium metabisulfite are then added to the wine must to kill any remaining live active yeasts. The wine must is then degassed to remove excess carbon dioxide

The juice can be from any juice known to ferment to produce an alcoholic beverage, including, but not limited to, grape, apple, pear, quince, peach, pineapple, pomegranate, banana, apricot, mango, kiwi, cherry, blueberry, raspberry, blackberry, elderberry, lingonberry, huckleberry, gooseberry, strawberry, goji berry, tomato, plum, watermelon, black currant, red currant and mixtures thereof. More preferred juices are grape, apple, pear, blueberry and pineapple. The most preferred juice is grape.

The inventive process can be used with both red and white grape juice to make red, white or rose wine. Furthermore, any grape varietal can be used, including, but not limited to, cabernet sauvignon, merlot, cabernet franc, malbec, petite verdot, pinot noir, gamay, syrah, grenache, mouvedre, petite syrah, carmenere, sangiovese, zinfandel, barbera, dolchetto, nebbiolo, Nero d'Avola, corvine, aglianico, lambrusco, teroldego, tempranillo, chardonnay, sauvignon blanc, riesling, semillon, viognier, marsanne, roussane, gewurtztraminer, gruner veltliner, gruner sylvaner, garganega, pinot grigio, moscato, muscadet, pinot blanc, and albarino.

In an embodiment of the present invention, the juice is present as a concentrate, and diluted with water to prepare a juice mixture, wherein the ratio of juice to water is in the range of between about 1:1 to 1:6, more preferably 1:2 to 1:4, and most preferably 1:2 to 1:3. For example, approximately 2.2 liters of juice concentrate can be diluted with approximately 5.4 liters of water to make approximately 2 gallons of wine.

The vessel used in fermenting and clearing the wine can be any suitable vessel adapted to contain a volume of liquid. There is no limit to the size of the vessel that can be used. Preferably, the vessel is adapted to hold at least 1 gallon of liquid. More preferably the vessel holds between 1 to 10 gallons of liquid, more preferably 1 to 5 gallons of liquid, and most preferably 2 gallons of liquid. The vessel preferably has a lid that can either form an air-impermeable seal or can lay flat against the top rim. The vessel also optionally has a handle for carrying the vessel. Furthermore, the vessel optionally contains a spout for dispensing the wine or beer wort.

In another embodiment of the invention, the juice is not concentrated, and is not diluted with water.

The bentonite is added to the wine must in order to absorb excess proteins during the fermentation process. About 0.1 to 10 grams of bentonite per gallon of juice or juice mixture is necessary, preferably 1 to 7 grams/gallon, more preferably 3-6 grams/gallon, and most preferably 4 to 5 grams/gallon.

The combination and concentration of diammonium phosphate and yeast hulls, or yeast “ghosts”, is believed to be an important factor in the accelerated fermentation process of the present invention. It is known to combine diammonium phosphate and yeast hulls in small quantities in order to restart a premature cessation of an alcoholic fermentation. Surprisingly, however, it has now been discovered that by adding the diammonium phosphate and yeast hulls in increased concentrations prior to the commencement of alcoholic fermentation, the fermentation process can be completed in five days or less.

Diammonium phosphate, (chemical formula (NH₄)₂HPO₄)), provides a nitrogen source necessary for the yeast to function to their capacity. The nitrogen, in the form of diammonium phosphate, is essentially yeast nutrition. In the present invention, diammonium phosphate is added to the juice or juice mixture prior to the addition of yeast at an amount of between about 5 to 40 grams per gallon of juice or juice mixture, preferably 10 to 15 grams per gallon, and most preferably 12 grams per gallon.

The yeast hulls are present in an amount of about 0.5 to 5 grams per gallon of juice mixture, more preferably about 1 to 3 grams per gallon, and most preferably 2.5 grams per gallon.

The vessel used in fermenting and clearing the wine can be any suitable vessel adapted to contain a volume of liquid. There is no limit to the size of the vessel that can be used. Preferably, the vessel is adapted to hold at least 1 gallon of liquid. More preferably the vessel holds between 1 to 10 gallons of liquid, more preferably 1 to 5 gallons of liquid, and most preferably 2 gallons of liquid. The vessel preferably has a lid that can either form an air-impermeable seal or can lay flat against the top rim. The vessel also optionally has a handle for carrying the vessel. Furthermore, the vessel optionally contains a spout for dispensing the wine or beer wort.

In a beer making process, the fermentation of a beer wort is accelerated by a process comprising adding bentonite, diammonium phosphate and yeast hulls to a liquid or dry malt extract combined with steeped hops in a water mixture in order to form a beer wort. An active yeast is then sprinkled on top of the wort and the mixture is then allowed to ferment in a warm, dark environment for 3 to 5 days, or until the fermentation process is nearly complete. Sediment from the wort is removed, and a level of carbonating sugar is then added to the wort must to promote carbonation with any remaining live active yeasts. The wort is then bottled to carbonate.

The wort can be created from any liquid or dry malt extract, hops and adjuncts known to ferment to produce an alcoholic beverage, including, but not limited to, barley malt, sorgum malt, pelletized hops, whole hops, and mixtures thereof.

The inventive process can be used with both liquid concentrated or dry malt extracts to make beer wort. Furthermore, any milled grain can be used, including, but not limited to, barley, sorgum, and wheat.

In an embodiment of the present invention, the wort is present as a concentrate, and diluted with water, steeped specialty grains and hops to prepare a wort mixture, wherein the ratio of wort to water is in the range of between about 1:1 to 1:6, more preferably 1:2 to 1:4, and most preferably 1:2 to 1:3. For example, approximately 2.2 liters of wort concentrate can be diluted with approximately 5.4 liters of water to make approximately 2 gallons of beer.

In another embodiment of the invention, the wort is not concentrated, and is not diluted with water.

The bentonite is added to the wort in order to absorb excess proteins during the fermentation process. About 0.1 to 10 grams of bentonite per gallon of wort or wort mixture is necessary, preferably 1 to 7 grams/gallon, more preferably 3-6 grams/gallon, and most preferably 4 to 5 grams/gallon.

The combination and concentration of diammonium phosphate and yeast hulls, or yeast “ghosts”, is believed to be an important factor in the accelerated fermentation process of the present invention. It is known to combine diammonium phosphate and yeast hulls in small quantities in order to restart a premature cessation of an alcoholic fermentation. Surprisingly, however, it has now been discovered that by adding the diammonium phosphate and yeast hulls in increased concentrations prior to the commencement of alcoholic fermentation, the fermentation process can be completed in five days or less.

In the present invention, diammonium phosphate is added to the beer wort or beer wort mixture prior to the addition of yeast at an amount of between about 5 to 40 grams per gallon of wort or wort mixture, preferably 10 to 15 grams per gallon, and most preferably 12 grams per gallon.

Yeast hulls are present in an amount of about 0.5 to 5 grams per gallon of juice mixture, more preferably about 1 to 3 grams per gallon, and most preferably 2.5 grams per gallon.

### EXAMPLE 1

### Process for Making Wine in Seven Days

### Day 1

Approximately 1.1 liters of grape juice are mixed with approximately 2.7 liters of water in a vessel to produce about 1 gallon of a juice mixture. To the juice mixture, 4 grams of bentonite are added and thoroughly mixed. Next, a mixture of approximately 12 grams diammonium phosphate and 2.5 grams of yeast hulls are added to the mixture, and stirred until the solids dissolve, and a must has formed. Once the solids have dissolved in the mixture, a 5 gram package of active yeast is sprinkled on top of the must. A lid is loosely fitted atop the vessel, and the vessel is placed in a 70-75° F. dark room for 3 days to allow the wine must to ferment.

### Day 4

After fermentation is complete, the wine must is drained into a transfer container, leaving sediment in the vessel. The sediment is removed, the vessel is rinsed with water, and the wine must is returned to the vessel. Next, approximately 1 tsp. of potassium sorbate and 1 tsp. of potassium metabisulfite are added to the wine must, and the mixture is stirred thoroughly for about 5 minutes in order to remove any excess carbon dioxide. About 1.75 tsp. of a first clearing agent, Kieselsol, is then thoroughly stirred into the wine must, and the wine must is then rested for about one hour. After the wine has rested, a second clearing agent, chitosan, is gently stirred into the wine must. The lid is then loosely fitted atop the vessel, and the vessel is again rested for 3 days in a 72-75° F. dark room.

### Day 7

The wine is transferred from the vessel to a transfer container, leaving sediment behind in the vessel. The wine is now ready for consumption.

### EXAMPLE 2

### Process for Making Beer in Seven Days

### Day 1

Approximately 1.1 liters of hopped malt concentrate are mixed with approximately 2.7 liters of water in a vessel to produce about 1 gallon of a wort mixture. To the wort mixture, 4 grams of bentonite are added and thoroughly mixed. Next approximately 7 grams diammonium phosphate and 2 grams of yeast hulls are added to the mixture, and stirred [until the solids dissolve, and a wort has formed]. Once the solids have dissolved in the mixture, a package of 5 to 7 grams active yeast is sprinkled on top of the must. A lid is loosely fitted atop the vessel, and the vessel is placed in a 70-75° F. dark room for 3 days to allow the wort must to ferment.

### Day 4

After fermentation is complete, the wort is drained into a transfer container, leaving sediment in the vessel. The sediment is removed, the vessel is rinsed with water, and the wort is returned to the vessel. Next, approximately 1 ounce of priming sugar (Dextrose Monohydrate) is added to the wort, and the mixture is stirred thoroughly. The mixture is transferred to individual bottles to complete carbonation within each vessel. The bottles are then stored in a dark warm area of 75 degrees or more to promote carbonation.

### Day 7

The wort is complete and ready for consumption.

### EXAMPLE 3

### Process for Making Wine in 7 Days

### Day 1

Approximately 1.1 liters of chardonnay grape juice concentrate was mixed with approximately 2.7 liters of water in a vessel to produce about 1 gallon of a juice mixture. To the juice mixture, 4 grams of bentonite was added and thoroughly mixed. Next, a mixture of approximately 12 grams diammonium phosphate and 2.5 grams of yeast hulls was added to the mixture, and stirred. The solids readily dissolved in the mixture after stirring for approximately 30 seconds. The resulting mixture is referred to as the must. Thereafter, a 5 gram package of LALVIN™ active yeast was sprinkled on top of the must. The must was stirred for an additional 30 seconds to dissolve the yeast in the must. Fermentation is initiated when the yeast is added to the must. At this stage, the must's appearance is very cloudy, virtually opaque. A lid was loosely fitted atop the vessel, and the vessel was left allowed to ferment in a dark, 72-75° F. room for three days.

### Day 4

About 72 hours after fermentation commenced, the specific gravity of the wine must was measured at 0.995, indicating that the must is completely or nearly completely residual sugar-free, and the fermentation process was complete and ready for stabilization. At this stage, the wine must exhibited a nearly clear, translucent appearance. The fermented wine must was then drained into a transfer container, leaving sediment in the vessel. After removing the sediment and rinsing the vessel, the wine must was returned to the vessel. Next, approximately 1 tsp. of potassium sorbate and 1 tsp. of potassium metabisulfite was added to the wine must and vigorously stirred for about 1 minute in order to remove any excess carbon dioxide. About 1.75 tsp. of a first clearing agent, Kieselsol, was thoroughly stirred into the wine must, and the wine must is then rested for about one hour. The vessel lid was then securely sealed and the vessel rested for 3 days in a 72-75° F. dark room.

### Day 7

After approximately 146 hours after commencement of fermentation, The wine is transferred from the vessel to a transfer container, leaving sediment behind in the vessel. The wine is now ready for consumption.

### COMPARATIVE EXAMPLE

### Day 1

Approximately 1.1 liters of chardonnay grape juice concentrate was mixed with approximately 2.7 liters of water in a vessel to produce about 1 gallon of a juice mixture. To the juice mixture, 4 grams of bentonite was added and thoroughly mixed. Next, a mixture of approximately 14.5 grams of prepackaged Fermaid K™ from Lallemand was added to the mixture, followed by mixing by stirring for approximately 30 seconds. The solids did not readily dissolve in the juice mixture, and there was noticeably amounts of clumped solids floating on top of the liquid juice mixture. A 3 gram package of Lalvin™ yeast was sprinkled on top of the juice mixture, and the mixture was yeast was mixed into the juice mixture by stirring for approximately 30 seconds. Fermaid K™ is a proprietary blend of diammonium phosphate, yeast hulls and nutrients. While the precise ratio of diammonium phosphate to yeast hulls is not known, the recommended addition rate to wine must is about 0.25 grams/liter, much lower than the concentration of diammonium phosphate and yeast hulls in the present invention.

Fermentation is initiated when the yeast is added to the must. At this stage, the must's appearance is very cloudy, virtually opaque. A lid was loosely fitted atop the vessel, and the vessel was left allowed to ferment in the same dark, 72-75° F. room as the wine must of Example 3 for three days.

### Day 4

About 72 hours after fermentation commenced, the specific gravity of the wine must was measured at 1.10, indicating that the must still contained measurable amounts of residual sugar, and fermentation was ongoing. The wine must exhibited a very cloudy, opaque appearance. The wine must was stirred slightly and left to continue fermenting.

### Day 7

The specific gravity of the wine must 146 hours after fermentation began remained at about 1.10, indicating that fermentation was “stuck”. The wine was stirred slightly and left to continue fermenting.

### Day 14

The specific gravity of the wine must two weeks after fermentation commenced was measured at 1.04. The appearance was cloudy. As fermentation was not complete, the wine was left to continue fermenting.

### Day 21

The specific gravity was measured at 1.04, and the appearance remained cloudy. It was determined that fermentation had stopped, despite the presence of residual sugar in the must. The wine must was deemed unsuitable for consumption.

I claim:

1. A method for the accelerated production of wine comprising:
a) mixing bentonite, diammonium phosphate, yeast hulls and a juice mixture prior to the onset of fermentation to form a wine must, said juice mixture comprising a fruit juice;
b) adding an active yeast to the wine must and allowing the wine must to ferment for up to seven days, or until the specific gravity of the wine must is 0.995 or lower; and
c) adding one or more clearing agents to the wine must,
wherein the diammonium phosphate is present in an amount of about 5 to 40 grams/gallon of juice mixture and the yeast hulls are present in an amount of about 0.5 to 2.5 grams/gallon of juice mixture.

2. The method according to claim 1 wherein the juice mixture comprises juice concentrate and water.

3. The method according to claim 2 wherein the ratio of juice concentrate to water is between about 1:1 to about 1:6.

4. The method according to claim 1 wherein the ratio of juice to water is between about 1:2 to 1:3.

5. The method according to claim 1 wherein the bentonite is present in an amount of about 0.5 to 10 grams per gallon of juice mixture.

6. The method according to claim 1 wherein the clearing agent is selected from the group consisting of Kieselsol, chitosan, egg whites, gelatine, Isinglass, metatartric acid, pectinase, polyvinyl polypyrollidone, sparkalloid and mixtures thereof.

7. The method according to claim 6 comprising at least two clearing agents selected from kieselsol and chitosan.

8. The method according to claim 1 wherein a natural fruit flavor is added to the wine must.

9. The method according to claim 8 wherein the natural fruit flavor is present at an amount of between about 2-10 fluid ounces per gallon of juice mixture.

10. The method according to claim 1 wherein the fruit juice comprises grape juice.

11. The method according to claim 1 wherein the active yeast is Saccharomyces cerevisiae bayanus.

12. The method according to claim 1 wherein the amount of active yeast added to the wine must is between 0.1 to 5 grams per gallon of juice mixture.

13. A method for the accelerated production of beer comprising:
a) mixing bentonite, diammonium phosphate, yeast hulls and barley hop prior to the onset of fermentation to form a wort, said wort mixture comprising barley or sorgum malt extract and hops.
b) Adding an active yeast to the wort and allowing the wort to ferment for up to seven days, or until the specific gravity of the wort is 1.01 or lower.
c) Adding Dextrose Monohydrate as priming sugar to promote carbonation; and
d) Bottling the wort,
wherein the diammonium phosphate is added in an amount of about 5 to 40 grams/gallon of wort mixture and the yeast hulls are added in an amount of about 0.5 to 2.5 grams/gallon of wort mixture.

14. The method according to claim 13 wherein the wort mixture additionally comprises water.

15. The method according to claim 13 wherein the ratio of wort to water is between about 1:1 to about 1:6.

16. The method according to claim 13 wherein the ratio of wort to water is between about 1:2 to 1:3.

17. The method according to claim 13 wherein the bentonite is present in an amount of about 0.5 to 10 grams per gallon of wort mixture.

18. The method according to claim 13 wherein the carbonating agent is Dextrose Monohydrate.

19. The method according to claim 13 wherein a carbonating agent (Dextrose Monohydrate) is added to the beer wort.

20. The method according to claim 13 wherein the active yeast is Active Brewers Yeast.

21. The method according to claim 13 wherein the amount of active brewers yeast added to the beer wort is between 1 to 7 grams per gallon of wort mixture.

22. The method according to claim 26 wherein the amount of active brewers yeast added to the beer wort is between 0.5 to 0.9 gram per gallon of wort mixture.

23. A kit for the accelerated production of wine, said kit comprising:
(a) a vessel suitable for holding a volume of liquid;
(b) a fruit juice or fruit juice concentrate;
(c) a first packet comprising bentonite, diammonium phosphate and yeast hulls; and
(d) a second packet comprising a clearing agent selected from the group consisting of Kieselsol, chitosan, egg whites, gelatine, Isinglass, metatartric acid, pectinase, polyvinyl polypyrollidone, sparkalloid and mixtures thereof.
